(19) United States
(12) Patent Application Publication
(10) Pub. No.: US 2011/0256032 A1
(43) Pub. Date: Oct. 20, 2011

(54) Exhaust Gas Treatment Device

(75) Inventors: Roland Schwarz, Esslingen (DE); Manfred Muller, Baltmannsweiler (DE)

(73) Assignee: J. Eberspaecher GmbH & Co. KG, Esslingen (DE)

(21) Appl. No.: 13/087,040

(22) Filed: Apr. 14, 2011

(30) Foreign Application Priority Data
Apr. 15, 2010 (DE) 102010015273.0

(51) Int. Cl. B01D 53/94; B01D 46/00

(52) U.S. Cl. 422/177; 55/385.3

(57) ABSTRACT

The present invention relates to an exhaust gas treatment device for an exhaust system of a combustion engine, more preferably of a motor vehicle, with a housing comprising a jacket and an outlet funnel, and with at least one exhaust gas treatment element which is arranged in the jacket and is axially supported on the housing via a support ring.

A simplified construction is obtained if the outlet funnel comprises an outer funnel connected to the jacket in a fixed manner and an inner funnel, which at an inner end facing the jacket carries the support ring, between inner funnel and outer funnel an insulation space is formed, which envelopes the inner funnel in circumferential direction, and if the inner end of the inner funnel contacts an inner end of the outer funnel facing the jacket.

### CROSS-REFERENCE TO RELATED PATENT APPLICATIONS

This patent application claims the benefit of German Patent Application No. 10 2010 015273.0, filed Apr. 15, 2010, the entire teachings and disclosure of which are incorporated herein by reference thereto.

### FIELD OF THE INVENTION

The present invention relates to a latent heat storage device as well as an exhaust gas treatment device for an exhaust system of a combustion engine, more preferably of a motor vehicle.

### BACKGROUND OF THE INVENTION

An exhaust gas treatment device can for example be a catalytic convertor or a particle filter or any combination thereof. Usually such an exhaust gas treatment device comprises a housing and at least one exhaust gas treatment element which can for example be a particle filter element or a catalytic converter element.

With usual design, the housing can comprise a jacket and an outlet funnel. In addition, an inlet funnel can also be present. The respective exhaust gas treatment element is usually enveloped in the circumferential direction by a bearing mat and arranged in the jacket. In addition, the respective exhaust gas treatment element is practically supported axially on the housing via a support ring.

For the thermal insulation the outlet funnel can operate with a so-called air gap insulation. To this end, it can have an outer funnel and an inner funnel, between which an insulation space is formed, which envelopes the inner funnel in circumferential direction.

Regularly problematic with such a design are thermally-induced expansion effects which can lead to relative movements or stresses between the individual components of the exhaust gas treatment device. For example, the inner funnel is exposed to higher temperatures than the outer funnel. In addition, the inner funnel upon heating-up of the exhaust system heats up more quickly than the outer funnel. Insofar as an insulation material is accommodated in the insulation space a direct exposure of the insulation space to exhaust gas should be additionally avoided in order to prevent damaging the insulation material and more particularly discharge of the insulation material. In addition, positioning and supporting of the support ring on the housing can be of as elaborate a design as desired.

### SUMMARY OF THE INVENTION

The present invention deals with the problem of stating an improved embodiment for an exhaust gas treatment device of the type mentioned at the outset, which is more preferably characterized by an improved fatigue durability.

According to the invention, this problem is solved through the subject of the independent claim. Advantageous embodiments are the subject of the dependent claims.

The invention is based on the general idea of matching outer funnel and inner funnel so that an inner end of the inner funnel facing the jacket comes to bear against the outer funnel on the outside and inside carries the support ring, while the outer funnel is connected to the jacket in a fixed manner. The axial forces transmitted to the support ring from the respective exhaust gas treatment element are directly transmitted from the inner funnel to the outer funnel so that the axial forces are finally absorbed by the outer funnel. Because of this it is possible for example to configure the inner funnel with a clearly smaller wall thickness than the outer funnel. For example, the wall thickness of the inner funnel amounts to a maximum of 50% of the wall thickness of the outer funnel. Through this design it is ensured at the same time that the insulation space on an inflow side facing the exhaust gas treatment element is closed, since there the inner ends of the two funnels bear against each other. Thus exposure of the insulation space to the exhaust gas flow can be effectively prevented.

According to a particularly advantageous embodiment the inner funnel on the outlet side, that is at an outer end facing away from the jacket relative to the outer funnel, can be arranged loosely at least in the flow direction. In particular, the inner funnel on the outlet side can be arranged in a free-standing manner in the outer funnel. This design makes possible relative movements between inner funnel and outer funnel without mechanical stresses occurring in the process. While with a loose arrangement a body contact between inner funnel and outer funnel is possible in principle, a free-standing arrangement avoids such contact, as a result of which the risk of damages through abrasion is also reduced.

Particularly advantageous is a configuration wherein an outer end of the inner funnel facing away from the jacket is spaced from an outer end of the outer funnel facing away from the jacket transversely to the flow direction, namely particularly along the entire circumference. Because of this it is clear that the outer ends of the two funnels are located near each other, so that the inner funnel substantially extends over the entire inner contour of the outer funnel, namely from the inner ends of the two funnels as far as to the outer ends of the two funnels. In this manner, the outer funnel between its ends is thermally insulated through the insulation space.

With a special embodiment a sleeve can be inserted in an outer end of the outer funnel facing away from the jacket and thus connected in a fixed manner. An outer end of the inner funnel facing away from the jacket is then practically spaced from this sleeve transversely to the flow direction, namely particularly along the entire circumference. Thus the inner funnel can also carry out thermally-induced movements relative to the sleeve without mechanical stresses occurring.

Particularly advantageous is an embodiment wherein on the inner end of the inner funnel an integrated holder for supporting the support ring is formed. Because of this, a separate holder for positioning or supporting the support ring can be omitted. This function is integrated in the inner funnel.

Practically, the holder can have a holding bottom which runs in circumferential direction and on which the support ring is axially supported. In addition or alternatively the holder can have a holding collar which runs in circumferential direction and on which the support ring is supported radially to the outside. In addition or alternatively the holder can have a holding flange which runs in circumferential direction and on which the support ring is supported radially to the inside. Practically, holding bottom, holding collar and holding flange can be integrally formed on the inner end of the inner funnel.

With another embodiment an integrated receptacle for holding the inner funnel can be formed on the inner end of the outer funnel in the region of the support ring or the holder. Because of this, a separate holder for example for holding and positioning the inner funnel can be omitted. The integrated holder more preferably makes possible a flat support of the inner funnel as a result of which the loading of the inner funnel and of the outer funnel is reduced.

The receptacle can comprise a circumferential receiving body in circumferential direction on which the holder, more preferably on a holding bottom, is axially supported. In addition or alternatively the receptacle can comprise a circumferential receiving collar in circumferential direction on which the holder, more preferably on a holding collar, is radially supported to the outside, and with which the outer funnel is connected to the jacket in a fixed manner. By way of the receiving bottom or by way of the receiving collar a flat support of the inner funnel on the outer funnel can be realised in the axial direction or in the radial direction, which reduces the load of the inner funnel and of the outer funnel. In particular, a positive positioning of the inner funnel on the outer funnel can be realised because of this, without a fastening being required between inner funnel and outer funnel. Thus, inner funnel and outer funnel can loosely contact each other in the region of the receptacle or be merely pressed together radially in order to ensure a desired position fixing at least for the assembly. In particular, a soldered connection or welded connection between inner funnel and outer funnel can be omitted.

Further important features and advantages of the invention are obtained from the subclaims, from the drawing and from the corresponding figure description by means of the drawing.

It is to be understood that the features mentioned above and still to be explained in the following cannot only be used in the respective combination stated, but also in other combinations or by themselves without leaving the scope of the present invention.

Other aspects, objectives and advantages of the invention will become more apparent from the following detailed description when taken in conjunction with the accompanying drawings.

### BRIEF DESCRIPTION OF THE DRAWINGS

Preferred exemplary embodiments of the invention are shown in the drawing and are explained in more detail in the following description.

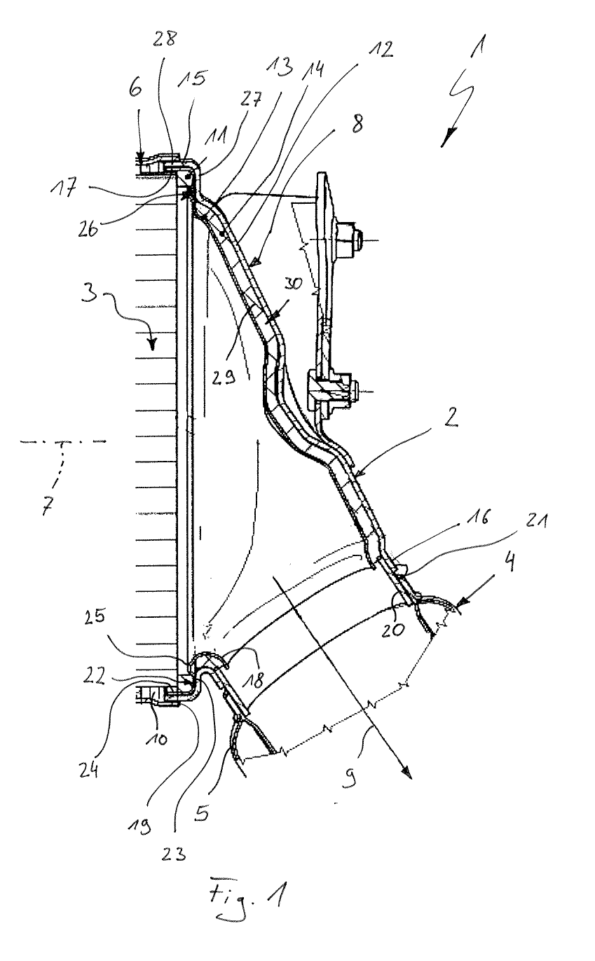

The only FIG. 1 shows a slightly perspective longitudinal section of an exhaust gas treatment device in the region of an outer funnel.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

According to FIG. 1, an exhaust gas treatment device 1 which is only partially shown comprises a housing 2 and at least one exhaust gas treatment element 3. The exhaust gas treatment device 1 is intended for use in an exhaust system 4, of which merely a component 5 is noticeable. The exhaust system 4 serves for carrying away exhaust gases of a combustion engine which can be more preferably located in a motor vehicle. The exhaust gas treatment device 1 can for example be a catalytic convertor or a particle filter or any combination thereof. Accordingly, the respective exhaust gas treatment element 3 for example can be a particle filter element or a catalytic convertor element.

The housing 2 has a jacket 6 which is only partially noticeable here, whose longitudinal centre axis 7 determines the longitudinal centre axis of the exhaust gas treatment device 1 and simultaneously the longitudinal direction or axial direction of the housing 2 or of the exhaust gas treatment device 1. The longitudinal direction or axial direction runs parallel to the longitudinal centre axis 7. In addition, the housing 2 comprises an outlet funnel 8 through which the exhaust gas exits the housing 2 and for example overflows into the further component 5 of the exhaust system 4. A flow direction prevailing at the outlet of the outlet funnel 8 is symbolised in FIG. 1 by an arrow 9. In addition to this, the housing 2 can optionally also comprise an inlet funnel which is now shown here.

The exhaust gas treatment element 3 is arranged in the housing 2, namely in the jacket 6. The exhaust gas treatment element 3 is practically enveloped in the circumferential direction by a bearing mat 10. The circumferential direction in this case relates to the longitudinal centre axis 7. The bearing mat 10 can for example be produced of a suitable bearing material. The bearing material of the bearing mat 11 can simultaneously act thermally insulating and accordingly, also represent a thermally insulating insulation material.

In addition, the exhaust gas treatment element 3 is axially supported on the housing 2 via a support ring 11. The support ring 11 can for example be produced of knitted wire mesh.

The outlet funnel 8 comprises an outer funnel 12 and an inner funnel 13, between which an insulation space 14 is formed, which envelopes the inner funnel 13 in the circumferential direction. The outer funnel 12 has an inner end 15 facing the jacket 6 and an outer end 16 facing away from the jacket 6. The inner funnel 13 also has an inner end 17 facing the jacket 6 and an outer end 18 facing away from the jacket 6.

The outer jacket 12 at its inner end 15 is connected to the jacket 6 in a fixed manner. In principle, any integrated design is conceivable wherein the outer funnel 12 is integrally formed on the jacket 6. For example, jacket 6 and outer funnel 12 can be produced of a sheet metal part through forming. However, FIG. 1 shows a preferred embodiment wherein jacket 6 and outer funnel 12 are separate components which are fastened to each other. In the example, the outer funnel 12 is inserted in the jacket 6. It can be soldered to the jacket 6. However, preferred is a welt seam 19, which more preferably circumferentially runs closed in the circumferential direction in order to connect the outer funnel 12 to the channel 6 in a fixed and gas-tight manner.

The inner funnel 13 at its inner end 17 carries the support ring 11 and with its inner end 17 bears against the inner end 15 of the outer funnel 12. In the shown example the inner funnel 13 with its inner end 17 axially and radially bears against the inner end 15 of the outer funnel 12. The radial direction in this case is based on the longitudinal centre axis 7.

In particular, it can be provided that the inner funnel 3 as with the embodiment shown here, exclusively bears against the outer funnel 12 in the region of its inner end 17. Between the inner ends 15, 17 and the outer 16, 18 of the two funnels 12, 13 the insulation space 14 is formed, which extends in a closed manner in the circumferential direction so that preferentially there is no contact between inner funnel 13 and outer funnel 12 in the region of the insulation space 14. In addition, the inner funnel 13 is practically arranged in the outer funnel 12 so that on the outlet side, that is in the region of its outer end 18, it is arranged in a free-standing manner in the outer funnel 12. Here, the inner funnel 13 with its outer end 18 can extend as far as to the outer end 16 of the outer funnel 12. In this case, the outer end 18 of the inner funnel 13 is arranged spaced from the outer end 16 of the outer funnel 12 transversely to the flow direction 9. Preferred in this case is an embodiment where this spacing is present between the two outer ends 16, 18 along the entire circumference, transversely to the flow direction 9.

In principle, however, other arrangements are also conceivable wherein the inner funnel 13 in the region of its outer end 18 is loosely arranged relative to the outer funnel 12. A loose arrangement for example can also be realised if the inner funnel 13 touches the outer funnel 12, but can be shifted along and in touch with said outer funnel. In the shown example a sleeve 20 is inserted in the outer end 16 of the outer funnel 12. The sleeve 20 can for example be connected to the outer funnel 12 in a fixed manner by means of a circumferential welt seam 21.

Said welt seam 21 then practically connects the outer end 16 of the outer funnel 12 at the face end to the outside of the sleeve 20. The spacing between the outer ends 16, 18 of the two funnels 12, 13 transversely to the flow direction 9 is practically matched so that the outer end 18 of the inner funnel 13 is also spaced from the sleeve 20 transversely to the flow direction 9, namely preferentially likewise along the entire circumference. Thus the inner funnel 13 at its outer end 18 is also arranged in a free-standing manner with respect to the sleeve 20.

On the inner end 17 of the inner funnel 13 a holder 22 can be integrally formed, with the help of which the support ring 11 is supported on the inner funnel 13. A separate holder can thus be omitted. The holder 22 can have a holding bottom 23 which runs circumferentially in the circumferential direction and on which the support ring 11 is supported in the axial direction. In the example, the holder 22 additionally comprises a holding collar 24, which likewise runs circumferentially in the circumferential direction and on which the support ring 11 is radially supported to the outside. Practically, the holding collar 24 is formed radially outside on the holding bottom 23. With the embodiment shown here, the holder 22 is additional provided with a holding flange 25 which likewise extends in circumferential direction and on which the support ring 11 is radially supported to the inside. The holding flange 25 in the axial direction is smaller than the holding collar 24. Furthermore, the holding flange 25 in this case is formed on the holding bottom 23 radially inside. The axial extension of the holding flange 25 from the holding bottom 23 is smaller than the axial extension of the support ring 11 from the holding bottom 23. In contrast with this, the axial extension of the holding collar 24 from the holding bottom 23 is greater than the axial extension of the support ring 11 from the holding bottom 23.

With the integral design shown, the inner funnel 13 in the region of its inner end 17 initially merges into the holding flange 25, following this into the holding bottom 23 and finally into the holding collar 24.

To realise a particularly intensive support of the inner funnel 13 on the outer funnel 12 in the region of the support ring 11, a receptacle 26 can be integrally formed on the outer funnel 12 at the inner end 15 of the outer funnel 12. The receptacle 26 thus serves to support or hold the inner funnel 13 in the region of the holder 22 or in the region of the support ring 11. For example, the receptacle 26 to this end can comprise a receiving bottom 27, which runs circumferentially in the circumferential direction and on which the holder 22 is axially supported. More preferably, the holding bottom 23 axially supports itself on the receiving bottom 27. In addition, the receptacle 26 can comprise a receiving collar 28 which runs circumferentially in the circumferential direction and on which the holder 22 is supported radially to the outside. More preferably, the holding collar 24 can be supported on the receiving collar 28 radially to the outside. The outer funnel 12 in the example is fastened to the jacket 6 by way of this receiving collar 28. Said receiving collar 28 in this case is additionally formed on the receiving bottom 27 radially outside. The dimensions and the shaping of the receptacle 26 are practically matched to the dimensions and the shaping of the inner end 17 of the inner funnel 13 so that both in axial direction and in radial direction a flat contact between inner funnel 13 and outer funnel 12 materialises. Here, it can be more preferably provided that the inner funnel 13 in the region of its inner end 17 loosely contacts the outer funnel 12. This loose contact in this case can be provided independently of the realisation of the receptacle 26. More preferably, such a loose contact or loose bearing between inner funnel 13 and outer funnel 12 can also be realised without such a receptacle 26. Through the loose contact between inner funnel 13 and outer funnel 12, relative movements between inner funnel 13 and outer funnel 12 are principally possible.

To realise a position fixing between inner funnel 13 and outer funnel 12 an axial clamping of the inner funnel 13 between the outer funnel 12 and the support ring 11 can be realised. Here, the inner funnel 13 is only clamped axially between the support ring and the outer funnel 12 in the region of its inner end 17. Optionally, it can be additionally provided to match the radial dimensions of the inner ends 15, 17 of the two funnels 12, 13 such that the inner funnel 13 sits in the outer funnel 12 with a press fit and because of this is likewise fixed in position. Such a radial pressing can be more preferably realised in conjunction with the receptacle 26.

With such a design, particularly fixing, for example by means of a soldered connection or a welded connection, between inner funnel 13 and outer funnel 12, can be omitted, which substantially simplifies the assembly. In particular, it can be provided to exclusively fasten the outlet funnel 8 to the jacket 6 via the outer funnel 12. As in the example shown, no direct connection between inner funnel 13 and jacket 6 is then present.

In the insulation space 14 a thermally insulating insulation material 29 can be arranged. It is likewise possible to arrange an insulation body 30 in the insulation space 14, which insulation body consists of a thermally insulating material 29. The insulation body 30 is pre-shaped or is a shaped body whose inner contour is matched to the outer contour of the inner funnel 13 and whose outer contour is matched to the inner contour of the outer funnel 12.

The insulation material 29 or the insulation body 30 is protected from direct exposure to hot exhaust gas since the inflow side of the insulation space 14 is closed in that the inner ends 15, 17 of the two funnels 12, 13 bear against each other.

The exhaust gas treatment element 3 can be designed as monolith. The exhaust gas treatment element 3 can be a metal body or a ceramic body. Preferably, the exhaust gas treatment element 3 is a ceramic monolith.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An exhaust gas treatment device for an exhaust system of a combustion engine, more preferably of a motor vehicle, comprising:
with a housing comprising a jacket and an outlet funnel,
with at least one exhaust gas treatment element which is arranged in the jacket and axially supported on the housing via a support ring,
wherein the outlet funnel comprises an outlet funnel connected to the jacket in a fixed manner and an inner funnel, which at an inner end facing the jacket carries the support ring,
wherein between inner funnel and outer funnel an insulation space is formed, which envelopes the inner funnel in circumferential direction,
wherein the inner end of the inner funnel bears against an inner end of the outer funnel facing the jacket.

2. The exhaust gas treatment device according to claim 1, wherein the inner funnel in the region of its outer end facing away from the jacket is arranged loosely relative to the outer funnel at least in the flow direction.

3. The exhaust gas treatment device according to claim 1, wherein the inner funnel on the outlet side is arranged in the outer funnel in a free-standing manner.

4. The exhaust gas treatment device according to claim 1, wherein an outer end of the inner funnel facing away from the jacket is spaced from an outer end of the outer funnel facing away from the jacket transversely to the flow direction, namely more preferably along the entire circumference.

5. The exhaust gas treatment device according to claim 1, wherein an outer end of the outer funnel facing away from the jacket is inserted into a sleeve.

6. The exhaust gas treatment device according to claim 1, wherein an outer end of the inner funnel facing away from the jacket is spaced from the sleeve transversely to the flow direction.

7. The exhaust gas treatment device according to claim 1, wherein an outer end of the inner funnel facing away from the jacket is spaced from the sleeve transversely to the flow direction along the entire circumference.

8. The exhaust gas treatment device according to claim 1, wherein on the inner end of the inner funnel an integrated holder for supporting the support ring is formed.

9. The exhaust gas treatment device according to claim 8, wherein the holder has a circumferential holding bottom running in circumferential direction, on which the support ring is axially supported.

10. The exhaust gas treatment device according to claim 8, wherein the holder has a circumferential holding collar running in circumferential direction, on which the support ring is radially supported to the outside.

11. The exhaust gas treatment device according to claim 8, wherein the holder has a circumferential holding flange running in circumferential direction, on which the support ring is supported radially to the inside.

12. The exhaust gas treatment device according to claim 8, wherein the holding collar is formed on the holding bottom radially outside.

13. The exhaust gas treatment device according to claim 8, wherein the holding flange is formed on the holding bottom radially inside.

14. The exhaust gas treatment device according to claim 1, wherein on the inner end of the outer funnel an integrated receptacle for holding the inner funnel is formed in the region of the support ring.

15. The exhaust gas treatment device according to claim 8, wherein the receptacle has a circumferential receiving bottom running in circumferential direction, on which the holder axially supported on a holding bottom.

16. The exhaust gas treatment device according to claim 8, wherein the receptacle has a circumferential receiving collar running in circumferential direction, on which the holder is supported on a holding collar radially to the outside and with which the outer funnel is connected to the jacket.

17. The exhaust gas treatment device according to the claim 8, wherein the receiving collar is formed on the receiving bottom radially outside.

18. exhaust gas treatment device according to claim 1, wherein the inner funnel contacts the outer funnel only in the region of its inner end.

19. The exhaust gas treatment device according to claim 1, wherein the inner funnel in the region of its inner end loosely contacts the outer funnel.

20. The exhaust gas treatment device according to claim 1, wherein the inner funnel is fixed in position on the outer funnel in that the inner funnel at its inner end is axially clamped between the support ring and the outer funnel.

21. The exhaust gas treatment device according to claim 1, wherein in the insulation space a thermally insulating insulation material is arranged.

22. The exhaust gas treatment device according to claim 1, wherein in the insulation space an insulation body of a thermally insulating insulation material is arranged.

23. The exhaust gas treatment device according to claim 14, wherein the receptacle has a circumferential receiving bottom running in circumferential direction, on which the holder axially supported on a holding bottom.

24. The exhaust gas treatment device according to claim 14, wherein the receptacle has a circumferential receiving collar running in circumferential direction, on which the holder is supported on a holding collar radially to the outside and with which the outer funnel is connected to the jacket.

25. The exhaust gas treatment device according to the claim 14, wherein the receiving collar is formed on the receiving bottom radially outside.
